(19) United States
(12) Patent Application Publication
(10) Pub. No.: US 2024/0404736 A1
(43) Pub. Date: Dec. 5, 2024

(54) SUPERCONDUCTING BULK, AND PRODUCTION METHOD FOR SUPERCONDUCTING BULK

(71) Applicants: NATIONAL INSTITUTE OF ADVANCED INDUSTRIAL SCIENCE AND TECHNOLOGY, Tokyo (JP); AISIN CORPORATION, Aichi (JP)

(72) Inventors: Shigeyuki ISHIDA, Ibaraki (JP); Hiraku OGINO, Ibaraki (JP); PavanKumarNaik SUGALI, Ibaraki (JP); Yoshinori TSUCHIYA, Ibaraki (JP); Akira IYO, Ibaraki (JP); Hiroshi EISAKI, Ibaraki (JP); Yoshiyuki YOSHIDA, Ibaraki (JP); Kenji KAWASHIMA, Aichi (JP); Yoshihisa KAMIYA, Aichi (JP)

(21) Appl. No.: 18/693,301

(22) PCT Filed: Jun. 27, 2022
(86) PCT No.: PCT/JP2022/025479

§ 371 Date: Mar. 19, 2024

(30) Foreign Application Priority Data
Sep. 24, 2021 (JP) 2021-156060

(51) Int. Cl. H01F 1/03; H01F 6/00

(52) U.S. Cl. CPC H01F 1/0311; H01F 6/00

(57) ABSTRACT

The critical current density of a superconducting bulk of an iron-based compound is improved compared with those of conventional superconducting bulks. A superconducting bulk (B) is a polycrystal of an iron-based superconductor, and has a degree of c-axis orientation, as determined by Lotgering's method, of not less than 0.2.

### TECHNICAL FIELD

The present invention relates to a superconducting bulk and a superconducting bulk production method.

### BACKGROUND ART

A superconducting bulk which is a polycrystal of an iron-based superconducting compound is known. For example, Patent Literature 1 discloses a superconducting bulk of Ba_{0.6}K_{0.4}Fe₂As₂, which is an example of an iron-based superconducting compound. Hereinafter, an iron-based compound having Ba partially substituted with K, such as Ba_{0.6}K_{0.4}Fe₂As₂, is referred to as K-doped Ba122.

Such a superconducting bulk traps a magnetic flux when undergoing field cooling, and thus functions as a magnet. Such a superconducting bulk-based magnet can be applied to a magnetic field source in magnetic resonance imaging (MRI) equipment in which nuclear magnetic resonance (NMR) method is used.

### CITATION LIST

### Patent Literature

### Patent Literature 1

Published Japanese Translation of PCT International Application, Tokuhyo, No. 2018-512737

### SUMMARY OF INVENTION

### Technical Problem

According to Patent Literature 1, starting materials are prepared such that the molar ratio between Ba, K, Fe, and As is 0.6:0.42:2:2, and a temporary sintered compact of the K-doped Ba122 is obtained with use of a hot isostatic press (HIP). Next, this sintered compact is made powdery by milling, and the powdery K-doped Ba122 is formed into a pellet with use of a cold isostatic press (CIP). Next, the pellet of K-doped Ba122 are wrapped with Ag foil and then inserted into a steel tube, and the steel tube is subjected to a CIP. With this CIP, the diameter of the steel tube containing the sample is reduced by approximately 10%. Subsequently, a HIP is carried out, so that a final sintered compact of K-doped Ba122 is obtained. Hereinafter, a step of obtaining a final sintered compact of K-doped Ba122 is referred to as a main sintering step, and the final sintered compact obtained by the production method is referred to as a superconducting bulk.

In a case of adopting a HIP in the main sintering step as described above, the critical current density of the superconducting bulk produced is obviously lower than that of a monocrystal of an iron-based superconducting compound. In view of this, it can be said that a superconducting bulk produced by a production method in which a HIP is adopted in a main sintering step does not exert full potential of an iron-based superconducting compound. In other words, conventional superconducting bulks of an iron-based compound are susceptible of an increase in critical current density.

Examples of sintering adopted in a main sintering step except a HIP include spark plasma sintering (SPS) and hot pressing. Even in a case of adopting SPS or hot pressing in a main sintering step, the critical current density of a superconducting bulk obtained is obviously lower than that of a monocrystal of an iron-based superconducting compound, as with the case of adopting a HIP in a main sintering step.

The present invention has been made in view of the above problem, and an object thereof is to improve the critical current density of a superconducting bulk of an iron-based compound compared with those of conventional superconducting bulks.

### Solution to Problem

In order to solve the above problem, a superconducting bulk in accordance with an aspect of the present invention is a polycrystal of an iron-based superconductor, and has a degree of c-axis orientation, as determined by Lotgering's method, of not less than 0.2.

In order to solve the above problem, a production method in accordance with an aspect of the present invention is a method for producing a superconducting bulk which is a polycrystal of an iron-based superconductor, and the method includes a main sintering step of sintering a pellet which is a temporary sintered compact while pressing the pellet in a uniaxial press, along a normal direction of principal surfaces of the pellet and such that a ratio of a principal surface size of the pellet to a thickness of the pellet increases, to obtain the superconducting bulk.

### Advantageous Effects of Invention

With an aspect of the present invention, it is possible to improve the critical current density of a superconducting bulk of an iron-based compound compared with those of conventional superconducting bulks.

### BRIEF DESCRIPTION OF DRAWINGS

(a) of FIG. 1 is a perspective view of a superconducting bulk in accordance with Embodiment 1 of the present invention. (b) of FIG. 1 is a schematic cross-sectional view of the superconducting bulk illustrated in (a) of FIG. 1.

FIG. 2 is a perspective view of the crystal structure of a compound which makes up a crystal grain contained in the superconducting bulk illustrated in FIG. 1.

FIG. 3 is a flowchart illustrating a flow of a production method in accordance with Embodiment 2 of the present invention.

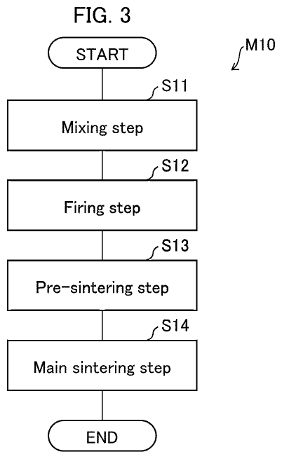

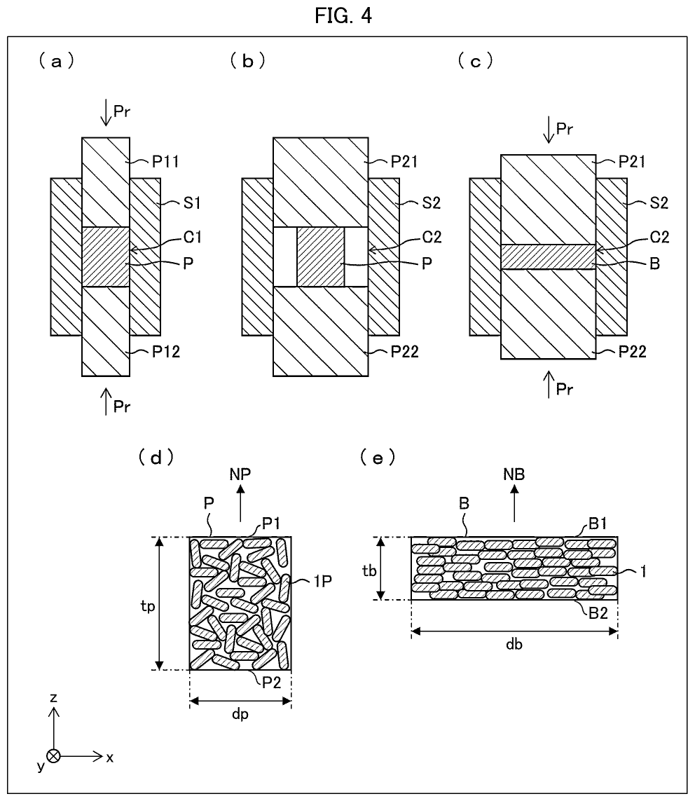

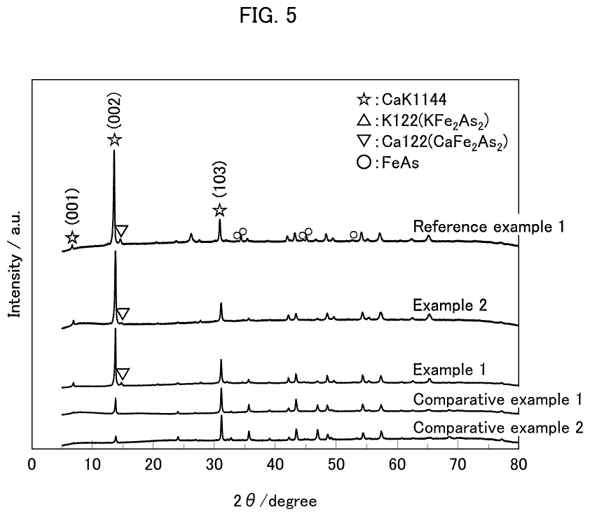

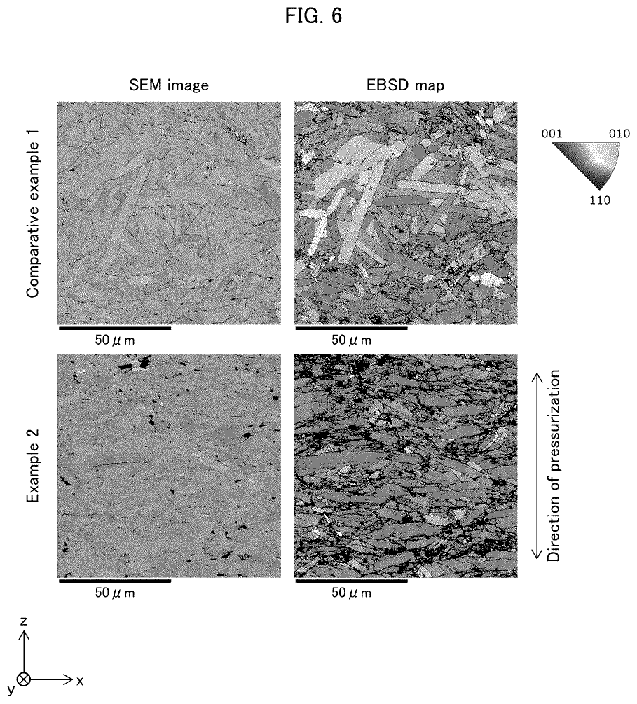

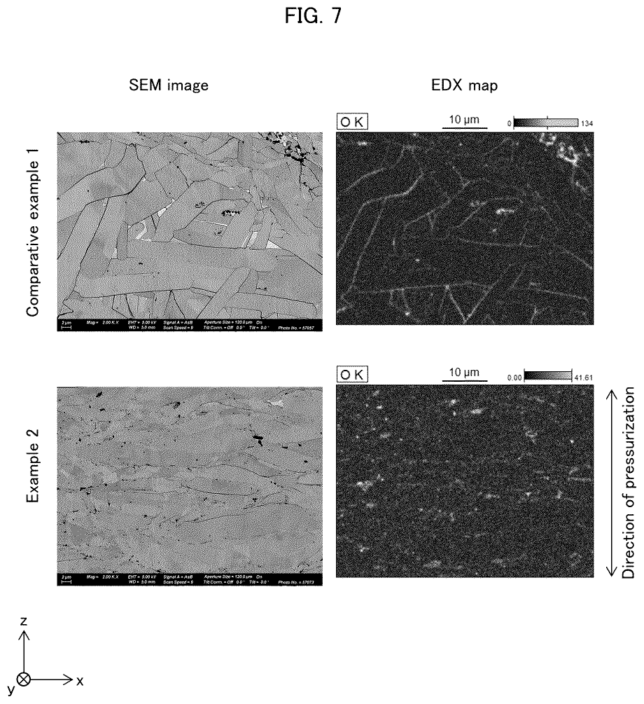

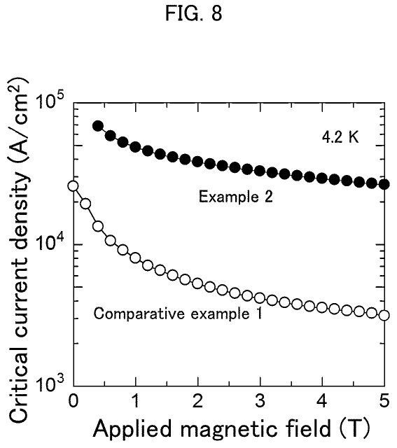

(a) of FIG. 4 is a cross-sectional view of a pellet after a pre-sintering step included in the production method illustrated in FIG. 3. (b) of FIG. 4 is a cross-sectional view of the pellet before a main sintering step contained in the production method illustrated in FIG. 3. (c) of FIG. 4 is a cross-sectional view of the superconducting bulk after the above main sintering step. (d) of FIG. 4 is a schematic cross-sectional view of the pellet obtained through the above pre-sintering step. (e) of FIG. 4 is a schematic cross-sectional view of the superconducting bulk obtained through the above main sintering step.

FIG. 5 is a graph illustrating X-ray diffraction (XRD) patterns of superconducting bulks of Examples 1 and 2, a small piece of Reference Example 1, a pellet of Comparative Example 1, and powder of Comparative Example 2 of the present invention.

FIG. 6 illustrates, in the upper row, an SEM image and an EBSD map of a cross section of the pellet of Comparative Example 1 illustrated in FIG. 5, and illustrates, in the lower row, an SEM image and an EBSD map of a cross section of the bulk of Example 2 illustrated in FIG. 5.

FIG. 7 illustrates, in the upper row, an SEM image and an EDX map of a cross section of the pellet of Comparative Example 1 illustrated in FIG. 5, and illustrates, in the lower row, an SEM image and an EDX map of a cross section of the bulk of Example 2 illustrated in FIG. 5.

FIG. 8 is a graph illustrating the dependence, on an applied magnetic field, of the critical current density of each of the superconducting bulk of Example 2 and the pellet of Comparative Example 1 illustrated in FIG. 5.

### DESCRIPTION OF EMBODIMENTS

### Embodiment 1

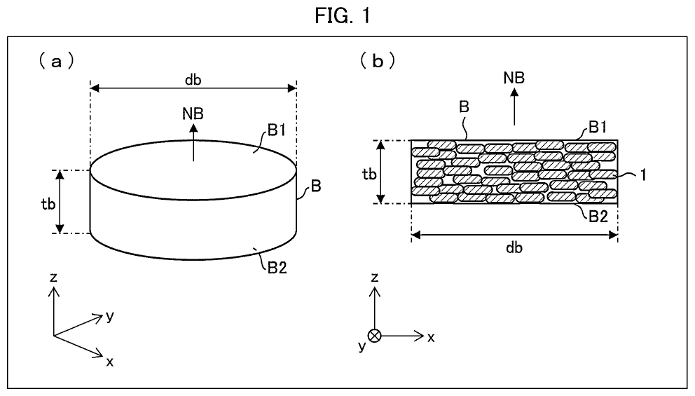

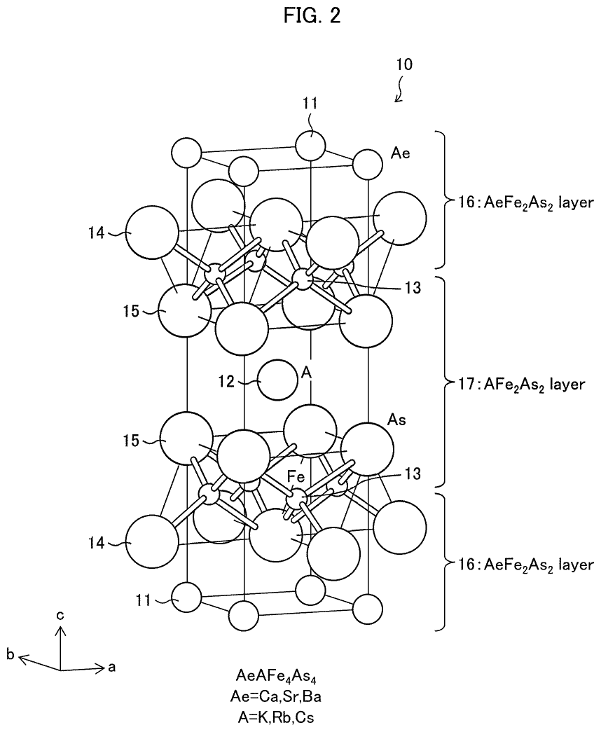

The following description will discuss a superconducting bulk B in accordance with Embodiment 1 of the present invention, with reference to FIGS. 1 and 2. (a) of FIG. 1 is a perspective view of a superconducting bulk B in accordance with Embodiment 1 of the present invention, and (b) of FIG. 1 is a schematic cross-sectional view of the superconducting bulk B illustrated in (a) of FIG. 1. FIG. 2 is a perspective view of the crystal structure of a compound 10 which makes up a crystal grain 1 contained in the superconducting bulk B illustrated in FIG. 1.

### <Outline of Compound>

As illustrated in (b) of FIG. 1, the superconducting bulk B is a polycrystal containing a plurality of crystal grains 1. Each of the crystal grains 1 consists of a monocrystal of the compound 10. The compound 10 is an iron-based superconductor which exhibits superconductivity in the range of temperatures lower than the critical temperature Tc thereof. Accordingly, like the compound 10, the superconducting bulk B, which is a polycrystal of the compound 10, exhibits superconductivity in the range of temperatures lower than the critical temperature Tc.

### (Chemical Formula Compound)

The compound 10 is represented by a chemical formula AeAFe₄As₄. In the formula, Ae is at least one element selected from the group consisting of Ca, Sr, and Ba, and, and A is at least one element selected from the group consisting of K, Rb, and Cs. In the present embodiment, Ca is selected as Ae, and K is selected as A. A monocrystal made up of a compound represented by the chemical formula AeAFe₄As₄ exhibits a high critical current density Jc, and this compound is therefore desirable as the compound 10.

### (Crystal Structure of Compound)

A crystal structure which can be configured in the compound 10 will be described below with reference to FIG. 2. The compound 10, which is represented by the chemical formula AeAFe₄As₄, can have a crystal structure in which AeFe₂As₂ layers 16 and AFe₂As₂ layers 17 are stacked in alternate layers along the c-axis, as illustrated in FIG. 2. The AeFe₂As₂ layers 16 each include Ae sites 11, Fe sites 13, and As sites 14. The AFe₂As₂ layers 17 each include an A site 12, the Fe sites 13, and As sites 15. The crystal structure illustrated in FIG. 2 has a primitive tetragonal crystal space group P4/mmm, and has a CaRbFe₄As₄ structure. The crystal structure of the compound 10 is anisotropic.

The crystal grain 1 formed by growth of such a crystal structure typically has a plate shape in which a layered structure extends along an ab-plane, the layered structure having layers stacked along the c-axis. In other words, the crystal grain 1 has an anisotropy, and principal surfaces of the plate shape have a normal direction which coincides with the c-axis of the crystal structure and have a tangent direction which coincides with the ab-plane of the crystal structure.

### (Another Configuration of Compound)

It should be noted that the compound 10 is not limited to a compound represented by the above chemical formula AeAFe₄As₄, but only needs to be a compound which contains element Fe and which exhibits superconductivity in the range of temperatures lower than the critical temperature Tc. A superconducting compounds which contains element Fe has an anisotropic crystal structure. A monocrystal made up of the compound 10 having this configuration also exhibits a high critical current density. Therefore, the compound 10 is desirable as a material of a superconducting bulk. Examples of the superconducting compound containing the element Fe include compounds obtained by substituting some of the constituent elements of a compound represented by the chemical formula AeAFe₄As₄ with other elements. Here are descriptions of such compounds.

Examples of the compound 10 include a compound represented by a chemical formula Ae₁₋ₓAₓFe₂As₂. In the formula, Ae is at least one element selected from the group consisting of Ca, Sr, and Ba. In the formula, A is at least one element selected from the group consisting of K, Rb, and Cs. In the formula, x is a number which falls within a range of 0<x<1. The crystal structure of the compound 10 having this configuration has a body-centered tetragonal crystal space group I4/mmm, and has a ThCr₂Si₂ structure.

Other examples of the compound 10 include a compound represented by a chemical formula Ae(Fe_{1-y}Tm_{y})₂As₂. In the formula, Ae is at least one element selected from the group consisting of Ca, Sr, and Ba. In the formula, Tm is at least one element selected from the group consisting of Co, Ni, Ru, Rh, Pd, Ir, and Pt. In the formula, y is a number which falls within a range of 0<y<1. The crystal structure of the compound 10 having this configuration has a body-centered tetragonal crystal space group I4/mmm, and has a ThCr₂Si₂ structure.

Other examples of the compound 10 include a compound represented by a chemical formula AeFe₂(As_{1-z}P_{z})₂. In the formula, Ae is at least one element selected from the group consisting of Ca, Sr, and Ba. In the formula, z is a number which falls within a range of 0<z<1. The crystal structure of the compound 10 having this configuration has a body-centered tetragonal crystal space group I4/mmm, and has a ThCr₂Si₂ structure.

Other examples of the compound 10 include a compound represented by a chemical formula LnFeAs(O,F). In the formula, Ln is at least one element selected from the group consisting of Y, La, Ce, Pr, Nd, Sm, Eu, Gd, and Dy. The crystal structure of the compound 10 having this configuration has a tetragonal crystal space group P4/nmm, and has a ZrCuSiAs structure.

Other examples of the compound 10 include a compound represented by a chemical formula Fe(Se,Te). The crystal structure of the compound 10 having this configuration has a tetragonal crystal space group P4/nmm, and has a PbO structure.

### <Outline of Superconducting Bulk>

The superconducting bulk B, which is a polycrystal of an iron-based superconductor, which is the compound 10, will be described below, with reference to FIG. 1.

The superconducting bulk B has the shape of a disc having a thickness tb and a diameter db, as illustrated in (a) of FIG. 1. In addition, the superconducting bulk B has two principal surfaces B1 and B2 which are parallel to each other and which face in opposite directions. In (a) of FIG. 1, an x axis and y axis which are orthogonal to each other in a plane in which the disc shape extends, a z axis orthogonal to the x axis and the y axis, and the normal direction NB of the principal surfaces B1 and B2 are illustrated.

From the viewpoint of achieving a mechanical strength desirable for the superconducting bulk B to be put into practical use as a superconductor such as, for example, a superconducting bulk magnet, the thickness tb of the superconducting bulk B is preferably not less than 1 mm, and it is more preferable when the thickness tb is greater. The upper limit of the thickness tb of the superconducting bulk B is not limited from the viewpoint of the mechanical strength.

In a case of being used as a superconducting bulk magnet, the superconducting bulk B traps a magnetic flux such that the superconducting bulk B is magnetized so as to have a magnetic field along the normal direction NB, that is, the thickness direction, although the present invention is not limited to this configuration.

The shape of the superconducting bulk B is not limited to the disc shape as illustrated in FIG. 2. Other examples of the shape of the superconducting bulk B include a plate shape having two principal surfaces which are parallel to each other and which face in opposite directions and having the shape of a ring, a square, a rectangular, or any other polygon, or any other shape when seen from the thickness direction in plan view. Further, the relationship in magnitude between the thickness tb and the diameter db can be set as appropriate according to uses. For example, in a case where the superconducting bulk B undergoes field cooling to be used as a magnet, the relationship is preferably such that tb>db.

### (Degree of Orientation of Crystal Grains in Superconducting Bulk)

As illustrated in (b) of FIG. 1, a plurality of crystal grains 1 are arranged with a high degree of orientation in the superconducting bulk B, and orientation texture is formed accordingly. With the formation of orientation texture, the superconducting bulk B exhibits an improved critical current density Jc, compared with conventional superconducting bulks.

The degree of orientation can be represented by using, as a measure, the degree of c-axis orientation, as determined by Lotgering's method, of the superconducting bulk B. The superconducting bulk B has a degree of c-axis orientation, as determined by Lotgering's method, of not less than 0.2. Further, the degree of c-axis orientation, as determined by Lotgering's method, of the superconducting bulk B is preferably not less than 0.4, from the viewpoint of further improving the critical current density Jc.

The degree of c-axis orientation as determined by Lotgering's method is calculated with use of the following formulae.

$$F = ( ρ - {ρ}_{0} ) / ( 1 - {ρ}_{0} )$$

$$ρ = \sum I ( 001 ) / \sum I ( hkl )$$

$${ρ}_{0} = \sum {I}_{0} ( 001 ) / \sum {I}_{0} ( hkl )$$

In the formulae, F represents the degree of c-axis orientation as determined by Lotgering's method. The term ΣI₀(001) represents a summation of peak intensities corresponding to (001) direction in the X-ray diffraction (XRD) pattern of the superconducting bulk B, and the term ΣI(001) represents such a summation of a sample having the same chemical composition as the superconducting bulk B but not having orientation texture formed therein, such as a powdery sample. The term ΣI₀(hkl) represents a summation of all the peak intensities in the X-ray diffraction (XRD) pattern of the superconducting bulk B, and the term ΣI(hkl) represents such a summation of a sample having the same composition as the superconducting bulk B but not having orientation texture formed therein, such as a powdery sample.

As illustrated in (b) of FIG. 1, the plurality of crystal grains 1 are arranged in the superconducting bulk B such that a direction (the ab-plane direction of the crystal grain 1) in which the plate shape of each of the crystal grains 1 extends corresponds to a direction (the in-plane direction of the principal surfaces B1 and B2) in which the disc shape of the superconducting bulk B extends. In other words, in each of the crystal grains 1, the c-axis direction of the crystal structure of that crystal grain 1 corresponds to the normal direction NB of the principal surfaces B1 and B2 of the superconducting bulk B.

In the present embodiment, the degree of coincidence of the normal direction NB with the c-axis direction of each crystal grain 1 is represented with use of the degree of c-axis orientation as determined by Lotgering's method. When the degree of c-axis orientation of the superconducting bulk B is higher, it is possible to further improve the critical current density Jc of the superconducting bulk B.

### (Another Configuration of Superconducting Bulk)

The superconducting bulk B may contain, in addition to the plurality of crystal grains 1, at least one element selected from the group consisting of tin, gallium, and indium, which are low-melting-point metals. The superconducting bulk B preferably contains the above-described low-melting-point metal in at least a part of the interface between the crystal grains 1, i.e., the grain boundary, although the present invention is not limited to this configuration. With this configuration, the low-melting-point metal strengthens the electrical coupling between the crystal grains 1 at the grain boundary. This further improves the critical current density Jc of the superconducting bulk B.

The superconducting bulk B may be impregnated with a resin which is typically an epoxy resin. Further, the surface of the superconducting bulk B may be coated with a resin. The resin for use in the coating may be a reinforced resin containing carbon fibers or the like, or may be a single-component resin. With these configuration, it is possible to enhance the mechanical strength of the superconducting bulk B.

In the superconducting bulk B, oxides are distributed in the form of islands, in parts of the grain boundary. Typically, oxides continuously distributed at the grain boundary so as to surround each crystal grain 1 are generated due to contamination by oxygen in the production process, and could cause a reduction in the critical current density Jc of the superconducting bulk. However, in the superconducting bulk B, oxides are distributed in the form of discontinuous islands, at the grain boundary. Accordingly, in at least parts of the grain boundary, the crystal grains 1 join together with no oxide present therebetween. In addition, the joint between the crystal grains 1 is formed by the ab-planes of the crystal structures. This joint therefore does not inhibit superconducting current from developing inside the superconducting bulk B. Thus, even in a case of containing an oxide, the superconducting bulk B is capable of exhibiting a high critical current density Jc.

### <Effect of Superconducting Bulk>

As described above, the superconducting bulk B is a polycrystal of an iron-based superconductor, and has a degree of c-axis orientation, as determined by Lotgering's method, of not less than 0.2.

With this configuration, the plurality of crystal grains 1 are arranged with a high degree of orientation in the superconducting bulk B. This reduces reduction or prevention of the critical current density caused by randomness of crystal orientation. This makes it possible for the superconducting bulk B to well exert the potential of a monocrystal of an iron-based superconductor, and exhibit an improved critical current density Jc, compared with conventional superconducting bulks.

The degree of c-axis orientation is preferably not less than 0.4.

With this configuration, it is possible for the superconducting bulk B to better exert the potential of a monocrystal of an iron-based superconductor, and exhibit a critical current density Jc which has been further improved to a greater degree, compared with those of conventional superconducting bulks.

The superconducting bulk B has a disc shape, and the superconducting bulk has the principal surfaces B1 and B2 a normal direction of which preferably corresponds to the c-axis orientation direction.

With this configuration, it is possible to further improve the critical current density Jc exhibited in a case where the superconducting bulk B traps a magnetic flux so as to be magnetized to have a magnetic field along the normal direction NB.

The superconducting bulk B has a thickness tb which is preferably not less than 1 mm.

With this configuration, it is possible to provide a superconducting bulk B which has a mechanical strength desirable for the superconducting bulk B to be put into practical use as a superconductor, such as, for example, a superconducting bulk magnet.

The superconducting bulk B preferably contains at least one element selected from the group consisting of tin, gallium, and indium.

With this configuration, the low-melting-point metal strengthens the electrical coupling between the crystal grains 1 at the grain boundary. This further improves the critical current density Jc of the superconducting bulk B.

The compound 10, which is an iron-based superconductor, is preferably represented by the chemical formula AeAFe₄As₄, where Ae is at least one element selected from the group consisting of Ca, Sr, and Ba, and A is at least one element selected from the group consisting of K, Rb, and Cs.

With this configuration, a monocrystal of the compound 10 exhibits a high critical current density Jc. Accordingly, a superconducting bulk which is a polycrystal of the compound 10 also exhibits a high critical current density Jc.

### Embodiment 2

### <Superconducting Bulk Production Method>

The following description will discuss a production method M10 in accordance with Embodiment 2 of the present invention, with reference to FIGS. 3 and 4. For convenience of description, a member having the same function and configuration as the member described in Embodiment 1 is assigned the same reference sign, and the description thereof is not repeated. FIG. 3 is a flowchart illustrating a flow of the production method M10. (a) of FIG. 4 is a cross-sectional view of a pellet P after the pellet P undergoes a pre-sintering step S13 included in the production method M10. (b) of FIG. 4 is a cross-sectional view of the pellet P before the pellet P undergoes a main sintering step S14 included in the production method M10. (c) of FIG. 4 is a cross-sectional view of the superconducting bulk B after a superconducting bulk B undergoes the main sintering step S14. (d) of FIG. 4 is a schematic cross-sectional view of the pellet P obtained through the pre-sintering step S13. (e) of FIG. 4 is a schematic cross-sectional view of the superconducting bulk B obtained through the main sintering step S14.

The production method M10 is a method for producing the superconducting bulk B. The production method M10 includes a mixing step S11, a firing step S12, the pre-sintering step S13, and the main sintering step S14, as illustrated in FIG. 3.

### (Mixing Step)

The mixing step S11 is a step of mixing together, as starting materials, the constituent elements of the compound 10, or compounds containing the respective constituent elements of the compound 10. Carrying out the mixing step S11 provides a mixture of the starting materials.

The starting materials only need to be the constituent elements of the compound 10, represented by the chemical formula AeAFe₄As₄, or compounds containing the respective constituent elements of the compound 10. In the formula, Ae is at least one element selected from the group consisting of Ca, Sr, and Ba, and, and A is at least one element selected from the group consisting of K, Rb, and Cs. In the present embodiment, Ca is selected as Ae, and K is selected as A. By selecting Ca as Ae and selecting K as A, it is possible to acquire commercially available products as the starting materials, at low cost.

Each of the starting materials is preferably powder. When each being powder, the starting materials are easy to uniformly mix together in the mixing step S11. The starting materials may be prepared in the form of powder in advance, or may be pulverized into powder in the mixing step S11.

The mixing step S11 is not particularly limited provided that the mixing step S11 is a step of mixing the starting materials together, but is preferably carried out in an inert gas atmosphere. When the mixing step S11 is carried out in an inert gas atmosphere, it is possible to reduce deterioration of the starting materials in the mixing step S11, the deterioration being caused mainly by contamination by oxygen. Examples of the inert gas include a nitrogen gas and an argon gas. An inert gas atmosphere environment can be provided by filling a glove box with the inert gas, although the present invention is not limited to this configuration.

An instrument used in the mixing step S11 is not particularly limited provided that it is possible to mix the starting materials together via the instrument. For example, a mortar can be used as the instrument.

### (Firing Step)

The firing step S12 is a step of firing the mixture of the starting materials, and carried out by heating a container in which the mixture is sealed. Carrying out the firing step S12 provides polycrystalline powder which contains the plurality of crystal grains 1 made up of the compound 10.

In the firing step S12, a heating temperature and a heating time can be set as appropriate according to the type of compound 10. In a case where the compound 10 is represented by a chemical formula CaKFe₄As₄ as in the present embodiment, the heating temperature is preferably not less than 800° C., and preferably not more than 1000° C. Further, the heating time is preferably not less than 1 hour. The heating time being not less than 1 hour makes it possible to sufficiently promote the firing of the mixture. Further, the heating time is preferably not more than 10 hours. This is because there is no significant difference in the obtained fired product even in a case where the heating time is longer than 10 hours. In the present embodiment, a temperature of 930° C. is adopted as the heating temperature, and a time of 5 hours is adopted as the heating time.

The container used for carrying out the firing step S12 only needs to be capable of being fired. The container used is preferably composed of a material less likely to react with the elements contained in the mixture and with oxygen, at not less than 1000° C. Examples of a preferable material include stainless steel.

A heating method used for carrying out the firing step S12 can be selected as appropriate. In the present embodiment, an electric furnace is adopted as this heating method.

### (Pre-Sintering Step)

The pre-sintering step S13 is a step of sintering the polycrystalline powder, and is carried out by heating and pressurizing the container in which the polycrystalline powder is sealed. Carrying out the pre-sintering step S13 provides the pellet P, which is a temporary sintered compact containing a plurality of crystal grains 1P.

The outline of the pre-sintering step S13 will be described below with reference to (a) of FIG. 4. In (a) of FIG. 4, a cylinder S1 having a circular inner shape, pistons P11 and P12 inserted through respective two openings at both ends of the cylinder S1, a cavity C1 formed by the cylinder S1 and the pistons P11 and P12 are illustrated. In the cavity C1, the container in which the polycrystalline powder is sealed is placed. To this container, heat is applied via the cylinder S1, and molding pressure Pr is also applied via the pistons P11 and P12. This causes the polycrystalline powder inside the container to be sintered, and the pellet P is obtained accordingly.

The outline of the pellet P obtained through the pre-sintering step S13 will be described below with reference to (d) of FIG. 4. The pellet P has the shape of a column having a thickness tp and a diameter dp, and has two principal surfaces P1 and P2 which are parallel to each other and which face in opposite directions. In (d) of FIG. 4, a normal direction NP which is a normal direction of the principal surfaces P1 and P2 is illustrated. As illustrated in (d) of FIG. 4, the pellet P contains a plurality of crystal grains 1P. In the pellet P, the plurality of crystal grains 1P are disposed with high randomness, and no orientation texture is formed accordingly.

In the pre-sintering step S13, a heating temperature and a heating time can be set as appropriate according to the type of compound 10. In a case where the compound 10 is represented by the chemical formula CaKFe₄As₄, the heating temperature is preferably more than 600° C., and more preferably near 700° C., although the present invention is not limited to this configuration. Further, the heating time is preferably not less than 3 minutes. The heating time being not less than 3 minutes makes it possible to obtain the pellet P having a high density through the pre-sintering. Further, the heating time is preferably not more than 1 hour. This is because there is no significant difference in the density of the obtained pellet P even in a case where the heating time is longer than 1 hour. In the present embodiment, a temperature of 700° C. is adopted as the heating temperature, and a time of 10 minutes is adopted as the heating time.

In the pre-sintering step S13, the molding pressure applied to the container can be set as appropriate according to the type of compound 10. For example, in a case where the compound 10 is represented by the chemical formula CaKFe₄As₄, the molding pressure is preferably not less than 10 MPa, and preferably not more than 200 MPa. In the present embodiment, a pressure of 50 MPa is adopted as the molding pressure.

The container used for carrying out the pre-sintering step S13 only needs to be capable of being heated and pressurized. The container used is preferably composed of a material less likely to react with the elements contained in the mixture and with oxygen and an inert gas, at not less than 1000° C. Preferred examples of the container used include a graphite container. Further, the container used for carrying out the pre-sintering step S13 and the container used for carrying out the firing step S12 may be the same container, or may be different containers.

A heating and pressurizing method used for carrying out the pre-sintering step S13 may be a conventionally known method. Examples of the heating and pressurizing method include spark plasma sintering (SPS) and hot pressing.

In the pre-sintering step S13, before the heating and pressurizing, at least one element selected from the group consisting of tin, gallium, and indium, which are low-melting-point metals, may be added to the polycrystalline powder. The reason for this will be described later.

### (Main Sintering Step)

The main sintering step S14 is a step of sintering the pellet P, which is a temporary sintered compact, while pressing the pellet P in a uniaxial press, along the normal direction NP of the principal surfaces P1 and P2 of the pellet P and such that a ratio of a principal surface size of the pellet P to the thickness tp of the pellet P increases, to obtain the superconducting bulk B. The main sintering step S14 is carried out by heating and pressurizing the container in which the pellet P is sealed, with use of a uniaxial press, although the present invention is not limited to this configuration.

As used herein, the “principal surface size” means a length representative of the size of the principal surface. Specifically, the “principal surface size” means, (i) in a case where the principal surface has the shape of a circle or a ring, the diameter of the circle or the outer diameter of the ring, (ii) in a case where the principal surface is a square, the length of each side of the square, and (iii) in a case where the principal surface has the shape other than a circle, a ring, and a square, the square root of the area of the principal surface. In Embodiment 2, since the principal surfaces B1 and B2 of the superconducting bulk B and the principal surfaces P1 and P2 of the pellet P, which is the precursor of the superconducting bulk B, are each circular, the principal surface size of the superconducting bulk B is the diameter db, and the principal surface size of the pellet P is the diameter dp.

The outline of the main sintering step S14 will be described below with reference to (b) and (c) of FIG. 4. In (b) of FIG. 4, a cylinder S2 having a circular inner shape, pistons P21 and P22 inserted through respective two openings at both ends of the cylinder S2, a cavity C2 formed by the cylinder S2 and the pistons P21 and P22 are illustrated. In the cavity C2, the pellet P is placed such that the normal direction NP of the principal surfaces P1 and P2 is in accordance with a direction of piston motion of the pistons P21 and P22, i.e., the z-axis direction. The pellet P is sintered while being pressed in a uniaxial press through application of the molding pressure Pr to the pellet P via the pistons P21 and P22 in the cavity C2. With this, the superconducting bulk B is obtained from the pellet P, which is a temporary sintered compact.

As illustrated in (c) of FIG. 4, when the molding pressure Pr is applied to the pellet P via the pistons P21 and P22 in a uniaxial press along the normal direction NP, i.e., the z axis, the pellet P is deformed such that the ratio of a principal surface size dp to the thickness tp increases. As a result, the superconducting bulk B as illustrated in (e) of FIG. 4 is obtained, the superconducting bulk B having the shape of a disc which has a thickness tb and a diameter db. In relation to the principal surface sizes relative to the thicknesses of the pellet P and the superconducting bulk B, there is a relationship expressed by the following Formula (i).

dp/tp<tb/db Formula (i)

The deformation of the pellet P promotes formation of orientation texture of crystal grains 1P inside the pellet P. Specifically, the plurality of crystal grains 1P move in a parallel manner and in a rotational manner such that the normal direction of the principal surfaces of the plate shape of each of the crystal grains 1P approaches the z axis, which is the direction of the pressurization, and gradually become arranged, as illustrated in (d) and (e) of FIG. 4. With this arrangement, the superconducting bulk B is obtained, the superconducting bulk B having the principal surfaces B1 and B2 the normal direction NB of which corresponds to the normal direction of the principal surfaces of the crystal grains 1, i.e., the c-axis direction of the crystal structure of the crystal grains 1. The superconducting bulk B thereby obtained can exhibit an improved critical current density Jc, compared with conventional superconducting bulks.

The above arrangement can be a distinctive phenomenon caused by pressing the pellet P containing the plurality of crystal grains 1P in a uniaxial press accompanied by deformation. Specifically, when the pellet P which does not contain the crystal grains 1P is sintered by a uniaxial press accompanied by deformation, creation of crystal grains is inhibited by the deformation, and the pellet P which contains a sufficient amount of crystal grains 1P therefore would not be obtained. Further, even in a case where the pellet P which contains the crystal grains 1P is pressed in a uniaxial press, when the pressing is not accompanied with deformation, the arrangement of the crystal grains 1P would not be promoted, and sufficient orientation texture would not be formed.

In the main sintering step S14, the pellet P preferably contains at least one element selected from the group consisting of tin, gallium, and indium, which are low-melting-point metals. With this configuration, by the action of the low-melting-point metal serving as a lubricant, the above-described arrangement of the crystal grains 1P is promoted, and the electrical coupling between the crystal grains 1P at the grain boundary is also strengthened in the superconducting bulk B obtained. This further improves the critical current density Jc of the superconducting bulk B.

In the main sintering step S14, the cavity C2 has a cavity size which is greater than the principal surface size dp of the pellet P. With this configuration, due to the uniaxial press, the pellet P deforms so as to extend along the tangent direction of the principal surfaces P1 and P2. This further promotes the arrangement of the crystal grains 1P inside the pellet P. Accordingly, the degree of orientation of the superconducting bulk B obtained further improves. As used herein, the term “cavity size” means a length representative of the size of the cavity. Specifically, the “cavity size” means, (i) in a case where the shape (hereinafter, referred to as the “shape of the cavity in plan view”) of the cavity seen along the z-axis direction in plan view is a circle, the diameter of the circle, (ii) in a case where the shape of the cavity in plan view is a square, the length of each side of the square, and (iii) in a case where the shape of the cavity in plan view is other than a circle and a square, the square root of the area of the shape of the cavity in plan view.

In the main sintering step S14, some of the crystal grains 1P and some of oxides present at the grain boundary are pulverized due to a uniaxial press. Next, as the pellet P deforms, fine pieces generated due to the pulverization move. Thus, after the main sintering step S14, the oxides present at the grain boundary are present so as to be distributed in the form of discontinuous islands due to the crush and the movement, although before the main sintering step S14, continuously present so as to surround each of the crystal grains 1P. This causes the number of regions in which the crystal grains 1P join together with no oxide present therebetween to be greater after the main sintering step S14 than before the main sintering step S14. It is therefore possible for the superconducting bulk B obtained to exhibit a high critical current density Jc.

A container used for carrying out the main sintering step S14 only needs to be capable of being heated and pressurized, and may be, for example, the same container that is used for carrying out the pre-sintering step S13. The container only needs to be sealed enough not to allow the pellet P contained therein to flow out when the pellet P undergoes a uniaxial press. Therefore, the container does not need to be subjected to complicated treatments required in a case of using an isostatic press, such as metal cladding carried out with use of silver wrap, a stainless steel pipe, or the like and welding of end portions of such a cladding. This enables the main sintering step S14 to easily be carried out.

In the main sintering step S14, a heating temperature and a heating time can be set as appropriate according to the type of compound 10. In a case where the compound 10 is represented by the chemical formula CaKFe₄As₄, the heating temperature is preferably more than 600° C., and more preferably near 700° C., although the present invention is not limited to this configuration. Further, the heating time is preferably not less than 3 minutes. The heating time being not less than 3 minutes makes it possible to sufficiently promote the deformation of the pellet P. Further, the above heating time is preferably not more than 1 hour. The heating time being not more than 1 hour makes it possible to produce, without taking undue time, the superconducting bulk B having sufficient mechanical strength.

In the main sintering step S14, the molding pressure can be set as appropriate according to the type of compound 10. For example, in a case where the compound 10 is represented by the chemical formula CaKFe₄As₄, the molding pressure is preferably not less than 10 MPa, and preferably not more than 200 MPa. In the present embodiment, a pressure of 50 MPa is adopted as the molding pressure. Further, in the main sintering step S14, a pressurizing time can be set independently of the above-described heating time. According to the present embodiment, the pressurizing time is equal to the heating time. That is, in the main sintering step S14 of the present embodiment, the heating is carried out concurrently with the pressurizing.

In the main sintering step S14, a method used for sintering the pellet P while pressing the pellet P in a uniaxial press may be a conventionally known method. In other words, the main sintering step S14 can be carried out by using existing production equipment of a producer, the equipment being capable of carrying out a uniaxial press. Thus, the main sintering step S14 is suitable for both small-scale production and large-scale production, and is carried out at low equipment cost. Examples of a method used for sintering the pellet P while pressing the pellet P in a uniaxial press include spark plasma sintering (SPS), hot pressing, and extrusion.

An atmosphere in which each of the steps S11 to S14 is carried out is preferably of a high-purity inert gas. Carrying out the main sintering step S14 in an atmosphere of a high-purity inert gas makes it possible to increase the critical current density Jc of the superconducting bulk B obtained. The type of inert gas can be set as appropriate in view of the degree of inertness of the gas and the costs. In addition, it is more preferable that the purity of the inert gas be higher. The amounts of O₂ and H₂O contained in the inert gas are each preferably less than 1 ppm. However, the purity of the inert gas can be set as appropriate in view of cost-effectiveness.

### <Effect of Superconducting Bulk Production Method>

As described above, the production method M10 is a method for producing the superconducting bulk B, which is a polycrystal of an iron-based superconductor, and includes the main sintering step S14 of sintering the pellet P, which is a temporary sintered compact, while pressing the pellet P in a uniaxial press, along the normal direction NP of the principal surfaces P1 and P2 and such that a ratio of a principal surface size of the pellet P to the thickness tp of the pellet P increases, to obtain the superconducting bulk B.

With this configuration, formation of orientation texture of the plurality of crystal grains 1P contained in the pellet P is promoted. It is therefore possible to produce the superconducting bulk B which well exerts the potential of a monocrystal of an iron-based superconductor, and exhibits an improved critical current density Jc, compared with conventional superconducting bulks.

It is preferable that in the main sintering step S14, the pellet P be sintered while being pressed in the uniaxial press in the cavity C2, and the cavity C2 have a cavity size which is larger than the principal surface size.

With this configuration, due to the uniaxial press, the pellet P deforms so as to extend along the tangent direction of the principal surfaces P1 and P2. This further promotes the arrangement of the crystal grains 1P inside the pellet P. Accordingly, the degree of orientation of the superconducting bulk B obtained further improves.

It is preferable that in the main sintering step S14, the pellet P be sintered while being pressed in the uniaxial press by spark plasma sintering or hot pressing.

With this configuration, it is possible to provide the main sintering step S14 which is suitable for both small-scale production and large-scale production, and is carried out at low equipment cost.

The pellet P preferably contains at least one element selected from the group consisting of tin, gallium, and indium.

With this configuration, by the action of the low-melting-point metal serving as a lubricant, the above-described arrangement of the crystal grains 1P is promoted, and the electrical coupling between the crystal grains 1P at the grain boundary is also strengthened in the superconducting bulk B obtained. This further improves the critical current density Jc of the superconducting bulk B.

It is preferable that the pellet P contain a compound represented by the chemical formula AeAFe₄As₄, where Ae is at least one element selected from the group consisting of Ca, Sr, and Ba, and A is at least one element selected from the group consisting of K, Rb, and Cs.

This configuration makes the production process simple, and it is therefore possible to produce the superconducting bulk B at low cost.

### <Variation>

The present invention is not limited to the embodiments, but can be altered by a skilled person in the art within the scope of the claims. The present invention also encompasses, in its technical scope, any embodiment derived by combining technical means disclosed in differing embodiments.

For example, the production method M10 in accordance with Embodiment 2 may further include, prior to the above-described mixing step S11, a weighing step of weighing out each of the compounds which are the starting materials.

### EXAMPLES

Examples 1 and 2, Reference Example 1 of the present invention, and Comparative Examples 1 and 2 will be described below with reference to FIGS. 5 to 8. FIG. 5 is a graph illustrating X-ray diffraction (XRD) patterns of superconducting bulks of Examples 1 and 2, a small piece of Reference Example 1, a pellet of Comparative Example 1, and powder of Comparative Example 2 of the present invention. The upper row of FIG. 6 illustrates an SEM image and an EBSD map of a cross section of a pellet of Comparative Example 1 illustrated in FIG. 5. The lower row of FIG. 6 illustrates an SEM image and an EBSD map of a cross section of a bulk of Example 2 illustrated in FIG. 5. The upper row of FIG. 7 illustrates an SEM image and an EDX map of a cross section of the pellet of Comparative Example 1 illustrated in FIG. 5. The lower row of FIG. 7 illustrates an SEM image and an EDX map of a cross section of the bulk of Example 2 illustrated in FIG. 5. FIG. 8 is a graph illustrating the dependence, on an applied magnetic field, of the critical current density of each of the superconducting bulk of Example 2 and the pellet of Comparative Example 1 illustrated in FIG. 5.

### <Production of Superconducting Bulk>

### Example 1

### (Mixing Step)

Prepared as the starting materials were commercially available elements Ca (purity >99.5 mol %), K (purity >99.5 mol %), Fe (purity >99.9 mol %), and As (purity >99.9999 mol %) which were in the form of powder. In order to obtain arsenide precursors which were CaAs, KAs, and Fe₂As, the elements contained in each of the precursors were selected from among the starting materials, and were mixed together. The arsenide precursors CaAs, KAs, and Fe₂As obtained were mixed together in a molar ratio of CaAs:KAs:Fe₂As=1:1.05:2. A powdery mixture was thus obtained.

### (Firing Step)

Next, the powdery mixture obtained was sealed in a stainless steel container. The mixing of the starting materials and the sealing-in of the powdery mixture were carried out in a glove box of an inert gas atmosphere (O₂<1 ppm, H₂O<1 ppm). Next, the stainless steel container in which the powdery mixture was sealed was fired with use of an electric furnace, and a polycrystalline powder was obtained accordingly. The heating temperature and the heating time of the firing were 930° C. and 5 hours, respectively.

### (Pre-Sintering Step)

A graphite container having an inner diameter of 10 mm was filled with the polycrystalline powder. Next, the graphite container was heated and pressurized with use of SPS, so that the polycrystalline powder was sintered. A pellet having a diameter of 10 mm was thus obtained. In the heating and pressurizing, the heating temperature, the heating time, and the molding pressure were 700° C., 10 minutes, and 50 MPa, respectively.

### (Main Sintering Step)

The obtained pellet having a diameter of 10 mm was put in the graphite container having an inner diameter of 20 mm. The cavity size of the graphite container was therefore greater than the principal surface size of the pellet. Next, by heating and pressurizing the graphite container in a uniaxial press with use of SPS, the pellet was deformed and sintered. A superconducting bulk of Example 1 was thus obtained. The heating temperature, the heating time, and the molding pressure were 700° C., 10 minutes, and 3 MPa, respectively. Before the uniaxial press, the thickness of the pellet was 5.1 mm, and after the uniaxial press, the thickness of the superconducting bulk of Example 1 was 2.2 mm.

### Example 2

A superconducting bulk of Example 2 was obtained with use of the same method as that of Example 1, except that the molding pressure in the main sintering step and the thickness of the superconducting bulk after uniaxial work were changed as presented in Table 1. It should be noted that the difference in the thickness of the pellet present between Examples 1 and 2 before the uniaxial press resulted from an error in operation of the production device.

The molding pressures in the main sintering step of Examples 1 and 2, the thickness of the pellet before the uniaxial work, and the thickness of the superconducting bulk after the uniaxial work are presented in Table 1.

### Reference Example 1

Production of a superconducting bulk of Reference Example 1 was attempted with use of the same method as that of Example 1, except that the molding pressure in the main sintering step and the thickness of the superconducting bulk after uniaxial work were changed as presented in Table 1. However, in Reference Example 1, the pellet ended up pulverized in the main sintering step, and a small piece of Reference Example 1 was obtained instead of a superconducting bulk.

### Comparative Example 1

As a pellet of Comparative Example 1, a pellet having a diameter of 10 mm as a result of carrying out the pre-sintering step was obtained with use of the same method as that of Example 1, except that the main sintering step was not carried out. That is, as a sintering step, only the pre-sintering step in which a molding pressure of 50 MPa was used was carried out.

### Comparative Example 2

As powder of Comparative Example 2, polycrystalline powder as a result of carrying out the firing step was obtained with use of the same method as that of Example 1, except that the pre-sintering step and the main sintering step were not carried out.

(Evaluation of Degree of c-Axis Orientation)

In order to evaluate the degree of c-axis orientation, XRD measurement was performed on the superconducting bulks of Examples 1 and 2, the small piece of Reference Example 1, the pellet of Comparative Example 1, and the powder of Comparative Example 2. The XRD patterns obtained were illustrated in FIG. 5. In the XRD patterns illustrated in FIG. 5, a star denotes a peak coming from a compound represented by the chemical formula CaKFe₄As₄, an inverted triangle denotes a peak coming from a compound represented by the chemical formula CaFe₂As₂, and a circle denotes a peak coming from a compound represented by the chemical formula FeAs.

In addition, the degrees of c-axis orientation, as determined by Lotgering's method, of the superconducting bulks of Examples 1 and 2, the small piece of Reference Example 1, and the pellet of Comparative Example 1 were calculated. The results of the calculations are presented in Table 1.

Further, in order to evaluate formation of orientation texture, scanning electron microscope (SEM) images of cross sections of the superconducting bulk of Example 2 and the pellet of Comparative Example 1, and the electron backscatter diffraction (EBSD) maps of the cross sections were captured. The results of the capture are presented in FIG. 6. In FIG. 6, the grayscale indicated in the upper right part corresponds to the crystal orientation of each of the crystal grains illustrated in the EBSD maps.

### (Evaluation of Oxide Distribution)

In order to evaluate the distribution of oxides present at grain boundary, scanning electron microscope (SEM) images of cross sections of the superconducting bulk of Example 2 and the pellet of Comparative Example 1, and the energy dispersive X-ray (EDX) maps of the cross sections were captured. The results of the capture are presented in FIG. 7. In the EDX map illustrated in the right column of FIG. 7, a region in which oxides are distributed is represented so as to be reduced in the shade.

### (Evaluation of Critical Current Density)

For each of the superconducting bulk of Example 2 and the pellet of Comparative Example 1, the dependence of the critical current density Jc on an applied magnetic field was measured at 4.2 K (absolute temperature). The results of the measurement are presented in FIG. 8. The critical current densities Jc of the superconducting bulks of Examples 1 and 2 and the pellet of Comparative Example 1 at 4.2 K under an applied magnetic field of 5 T are also presented in Table 1.

### [Table 1]

TABLE 1
Production conditions and evaluation results of Examples and Comparative Examples

| | | | | | Evaluation results | |
|---|---|---|---|---|---|---|
| | Production conditions in main sintering step | | | | Degree of | Critical |
| | Molding | Thickness tp | Thickness tb | Work rate | c-axis | current |
| | pressure | before | after | (tp − tb)/ | orientation | density |
| | Pr | pressurization | pressurization | tp * 100 | F | Jc |
| | [MPa] | [mm] | [mm] | [%] | [—] | [kA/cm²] |
| Example 1 | 3 | 5.1 | 2.2 | 56.9 | 0.428 | 14 |
| Example 2 | 50 | 5.2 | 1.4 | 73.1 | 0.539 | 26 |
| Reference Example 1 | 50 | 4.8 | 1.0 | 79.2 | 0.547 | — |
| Comparative Example 1 | — | — | — | — | 0.104 | 3 |
| Comparative Example 2 | — | — | — | — | 0 | — |

### <Discussion>

As illustrated in FIG. 5, each of the superconducting bulks of Examples 1 and 2 obtained by carrying out the main sintering step exhibits a peak at around 2θ=14°, the peak corresponding to (002) direction of the crystal structure of a compound represented by the chemical formula CaKFe₄As₄. Further, the intensities of these peaks were greater than the intensities of peaks to which the pellet of Comparative Example 1 and the powder of Comparative Example 2 correspond, the pellet of Comparative Example 1 and the powder of Comparative Example 2 being obtained without carrying out the main sintering step. Specifically, the superconducting bulks of Examples 1 and 2 each exhibit a degree of c-axis orientation as high as not less than 0.4, as presented in Table 1. This shows that carrying out the main sintering step caused the crystal grains contained in the pellet to be arranged with a high degree of orientation, and orientation texture was formed accordingly.

As illustrated in FIG. 6, the number of crystal grains the c-axes of which became oriented in the direction of pressurization was greater for the superconducting bulk of Example 2 than for Comparative Example 1. This shows that carrying out the main sintering step caused the crystal grains to be arranged not only with a high degree of orientation but also such that the normal direction of the principal surfaces of the superconducting bulk and the directions of the c-axis orientation correspond to each other.

As illustrated in FIG. 7, in the pellet of Comparative Example 1, oxides were continuously distributed at the grain boundary. In contrast, in the superconducting bulk of Example 2, oxides were distributed in the form of islands. In addition, the crystal grains contained in the superconducting bulk of Example 2 were pulverized finer and had a smaller grain size than those contained in the pellet of Comparative Example 1. This shows that carrying out the main sintering step caused some of the crystal grains and some of the oxides to be pulverized and moved, and caused the oxides to be localized, and thereby promoted joining together of the crystal grains with no oxide present therebetween.

As illustrated in FIG. 8, the superconducting bulk of Example 2 exhibited an improved critical current density Jc under conditions of a temperature of 4.2 K and a magnetic field ranging from 0.5 T to 5 T, compared with the pellet of Comparative Example 1. As presented in Table 1, the superconducting bulk of Example 1 also exhibited an improved critical current density Jc. This shows that a superconducting bulk which is a polycrystal of an iron-based superconductor, the superconducting bulk having a degree of c-axis orientation, as determined by Lotgering's method, of not less than 0.2, exhibits an improved critical current density Jc, compared with conventional superconducting bulks.

As presented in Table 1, in Examples 1 and 2, when the work rate in the main sintering step was higher, the degree of c-axis orientation tended to be higher. In addition, the results of evaluation of the superconducting bulks of Examples 1 and 2 have suggested that when the degree of c-axis orientation is higher, the critical current density Jc is higher. The superconducting bulks of Examples 1 and 2 had mechanical strengths desirable for practical use, although this is not illustrated in the drawings.

### REFERENCE SIGNS LIST

B: Superconducting bulk
B1, B2: Principal surface
NB: Normal direction
1: Crystal grain
P: Pellet
P1, P2: Principal surface
C1, C2: Cavity

1. A superconducting bulk which is a polycrystal of an iron-based superconductor, the superconducting bulk having a degree of c-axis orientation, as determined by Lotgering's method, of not less than 0.2.

2. The superconducting bulk according to claim 1, wherein
the degree of c-axis orientation is not less than 0.4.

3. The superconducting bulk according to claim 1, wherein
the superconducting bulk has a disc shape, and
the superconducting bulk has principal surfaces a normal direction of which corresponds to a direction of the c-axis orientation.

4. The superconducting bulk according to claim 3, wherein
the superconducting bulk has a thickness of not less than 1 mm.

5. The superconducting bulk according to claim 1, wherein
the superconducting bulk contains at least one element selected from the group consisting of tin, gallium, and indium.

6. The superconducting bulk according to claim 1, wherein
the iron-based superconductor is a compound represented by a chemical formula AeAFe₄As₄, where
Ae is at least one element selected from the group consisting of Ca, Sr, and Ba, and
A is at least one element selected from the group consisting of K, Rb, and Cs.

7. A method for producing a superconducting bulk which is a polycrystal of an iron-based superconductor, comprising
a main sintering step of sintering a pellet which is a temporary sintered compact while pressing the pellet in a uniaxial press, along a normal direction of principal surfaces of the pellet and such that a ratio of a principal surface size of the pellet to a thickness of the pellet increases, to obtain the superconducting bulk.

8. The method according to claim 7, wherein
in the main sintering step, the pellet is sintered while being pressed in the uniaxial press in a cavity, and the cavity has a cavity size which is larger than the principal surface size.

9. The method according to claim 7, wherein
in the main sintering step, the pellet is sintered while being pressed in the uniaxial press by spark plasma sintering or hot pressing.

10. The method according to claim 7, wherein
the pellet contains at least one element selected from the group consisting of tin, gallium, and indium.

11. The method according to claim 7, wherein
the pellet contains a compound represented by a chemical formula AeAFe₄As₄, where
Ae is at least one element selected from the group consisting of Ca, Sr, and Ba, and
A is at least one element selected from the group consisting of K, Rb, and Cs.
